(19) United States
(12) Patent Application Publication
(10) Pub. No.: US 2023/0363417 A1
(43) Pub. Date: Nov. 16, 2023

(54) PRODUCTS AND METHODS FOR INCREASING NITRIC OXIDE PRODUCTION AND MANAGING OXIDATIVE STRESS

(71) Applicant: Kent Corporation, Muscatine, IA (US)

(72) Inventors: Xiaowen Guo, Muscatine, IA (US); Douglas A. Stetzer, Superior, WI (US)

(21) Appl. No.: 18/022,343

(22) PCT Filed: Aug. 20, 2021
(86) PCT No.: PCT/US2021/046998

§ 371 Date: Feb. 21, 2023

Related U.S. Application Data
(60) Provisional application No. 63/068,740, filed on Aug. 21, 2020.

(51) Int. Cl. A23K 20/142; A23K 20/105; A23K 20/174; A23K 20/20; A23K 50/75

(52) U.S. Cl. CPC A23K 20/142; A23K 20/105; A23K 20/174; A23K 20/30; A23K 50/75

(57) ABSTRACT

Disclosed are animal feeding products and methods contemplated to be useful to increase nitric oxide production and mange oxidative stress in an animal. The animal feeding products generally comprise arginine, choline, an ascorbyl compound, and zinc. Also contemplated is a method of feeding an animal comprising administering doses of arginine, choline, an ascorbyl compound, and zinc to a target animal over a period of time. The dose of arginine may range from about 0.2-10% total weight of feed/head/day. The dose of choline may range from about 0.1-10% total weight of feed/head/day. The dose of the ascorbyl compound may range from about 0.015-10% total weight of feed/head/day. The dose of zinc may range from about 0.01-10% total weight of feed/head/day.

### CROSS-REFERENCE TO RELATED APPLICATIONS

This application claims benefit of U.S. Provisional Application No. 63/068,761, filed Aug. 21, 2020, which is hereby incorporated herein by reference in its entirety.

### TECHNICAL FIELD

The present disclosure relates generally to feed products comprising arginine, and more specifically, to animal feed products comprising arginine, choline, and one or more antioxidants.

### BACKGROUND

Among chickens, meat-producing broiler strains are prone to severe pulmonary hypertension and congestive heart failure. The increased susceptibility to pulmonary hypertension of broiler chickens is believed to be the inadvertent consequence of selective breeding for rapid body growth and increased feed conversion. Vasoconstriction among broiler chickens is postulated to contribute to mortality and impact meat quality.

For instance, death on arrival (DOA), which refers to mortality during pre-slaughter catching or transportation, is a problem among broiler chickens. It is postulated that DOA is caused by stress which triggers the constriction of coronary vessels resulting in poor blood flow to the heart muscle. If progressive, poor blood flow may result in a heart attack and death.

Woody Breast syndrome is a myopathy characteristically expressed by fast-growing and high-yielding broiler chicken strains. Woody Breast affects meat quality and causes significant changes in the texture and functionality of poultry fillets. The texture of poultry fillets impacted by Woody Breast is harder and exhibits more springiness and cohesiveness than normal fillets. It is postulated that Woody Breast may be caused by a constricted supply of blood and oxygen, oxidative stress, and the decline of waste product removal from muscles in the form of carbon dioxide and lactic acid.

It would be desirable to mitigate Woody Breast syndrome and rates of death on arrival in target animals, particularly chickens. Additionally, it would be desirable to improve feed efficiency in animals such as chickens. Feed efficiency, as measured by feed conversion ratio, is a measure of how efficiently the animal gains weight, and improvements in feed conversion ratio are economically desirable. Generally, the feed conversion ratio represents the proportion of feed converted to body mass gain, with lower values for a particular animal feed signifying that the feed is more efficient. Depending on the cost of the ingredients in the feed, the feed conversion ratio may signify a more economical feeding program.

### SUMMARY

Provided herein are animal feeding products and methods that may increase nitric oxide production and manage oxidative stress in a target animal. It is postulated that the animal feeding methods and products described herein may be used to balance oxidative stress, alleviate heart disease contributing to DOA, and mitigate Woody Breast Syndrome in poultry. The animal feeding products and methods described herein may be used to improve meat quality in a target animal, without negatively impacting meat yield. Additionally, it has surprisingly been found that certain formulations described herein can improve feed conversion ratio.

The method of feeding one or more target animals may comprise administering doses of arginine, choline, an ascorbyl compound, and zinc to a target animal. The dose of arginine may range from about 0.1-10%, about 0.2-10%, or about 2-10% total weight of feed/head/day. The dose of choline may range from about 0.03-10%, about 0.1-10%, or about 0.3-10% total weight of feed/head/day. The dose of the ascorbyl compound may range from about 0.015-10% or about 0.04-10% total weight of feed/head/day. The dose of zinc may range from about 0.001-10%, about 0.01-10%, or about 0.3-10% total weight of feed/head/day.

The doses of arginine, choline, the ascorbyl compound, and zinc be may be administered to a chicken in amounts sufficient to reduce Woody Breast syndrome relative to administering arginine alone. The doses of arginine, choline, the ascorbyl compound, and zinc may also be administered to a chicken in amounts sufficient to reduce rates of death on arrival. Also, the doses of arginine, choline, the ascorbyl compound, and zinc may also be administered to a chicken in an amount effective to improve feed conversion ratio.

The method of feeding one or more target animals may also comprise adding an animal feed supplement to a water supply in an amount ranging from about 0.001-2000 g of of animal feed supplement per gallon of water. The animal feed supplement may comprise about 10-50 wt. % arginine, about 10-50 wt. % choline, about 1-10 wt. % an ascorbyl compound, and about 1-15 wt. % zinc. The water supply is administered to one or more target animals over a period of time.

The animal feed product may comprise arginine, choline, an ascorbyl compound, and zinc, wherein the amount of each component ranges from about 0.001-10% by dry basis weight of the animal feed product irrespective of the form of administration. The animal feed product may be a liquid or dry feed product.

It should be appreciated that in some forms, feeding may be discontinued to the target animal about 2 to about 24 hours prior to transport.

### DETAILED DESCRIPTION

The present disclosure provides animal feed products comprising arginine, choline, an ascorbyl compound, and zinc. Also provided herein are methods of feeding an animal comprising administering doses of arginine, choline, an ascorbyl compound, and zinc to one or more target animals.

Arginine is an amino acid that may prevent or treat heart and circulatory diseases. Arginine is often found at active sites in proteins and enzymes due to its amine-containing side chain. Arginine increases nitric oxide (NO) production, relaxing blood vessels and treating angina and other cardiovascular problems. Among broiler chickens, increases in dietary arginine may reduce the incidence of severe pulmonary hypertension, which suggests that the vasodilation capacity of the pulmonary circulation in broiler chickens is impaired and that increased availability of arginine is restorative. Arginine may be useful to mitigate Woody Breast syndrome among broiler chickens. Arginine may include both the DL- and L-forms and is physiologically active in the L-form.

In addition to L-arginine, there are other vasodilators such as the nitric oxide-dependent vasodilator acetylcholine. NO is produced from arginine through the enzymatic action of nitric oxide synthase (NOS). NOS can be activated in a calcium-dependent way. Acetylcholine acts on specific receptors on the endothelial cell membrane to increase the intracellular concentration of calcium and activate NOS to produce nitric oxide. Choline converts to acetylcholine. Thus, choline increases the level of acetylcholine and is believed to enhance the NO-producing efficacy of arginine. Choline may be provided by any suitable choline compound such as choline bitartrate, choline L-bitartrate, choline chloride, ferric choline citrate, ferric choline citrate complex, choline pantothenate, and choline xanthate.

Antioxidants play a role in reducing oxidative stress in muscle tissue. Vitamin-C is an antioxidant which serves as an electron donor in a variety of enzymatic reactions. Sources of vitamin-C include ascorbyl compounds which may include one or more of ascorbic acid, ascorbyl palmitate, sodium ascorbate, calcium ascorbate, potassium sorbate, L-ascorbyl-2-polyphosphate, or L-ascorbyl-2-sulfate.

Zinc is a mineral with antioxidant properties. Zinc may be provided by any suitable zinc compound such as zinc acetate, zinc carbonate, zinc chloride, zinc chloride diamine complex, zinc gluconate, zinc hydroxychloride, zinc oxide, zinc picolinate, zinc propionate, zinc stearate, zinc sulfate, zinc methionine, and zinc sulfate monohydrate.

A dose of arginine may be administered to a target animal in an amount effective to increase nitric oxide production or vasodilation in the target animal. A workable dose of arginine may comprise about 0.001-10% the total weight of feed/head/day. The dosage range for arginine may be about 0.1-10%, about 0.2-10%, about 2-9%, about 3-8%, or about 4-7% the total weight of feed/head/day. The lower end of the dosage range for arginine may be about 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, 1%, 1.3%, 1.5%, 1.7%, 2%, 2.3%, 2.5%, 2.7%, 3%, 3.3%, 3.5%, 3.7%, 4%, 5%, 6%, or 7% the total weight of feed/head/day. The upper end of the dosage range for arginine may be about 10%, 9%, 8%, 7%, 6%, 5%, 4%, or 3% the total weight of feed/head/day. In one example, when the target animal is a chicken, the dose of arginine may be administered in an amount ranging from about 0.001-30 g/head/day, about 0.1-25 g/head/day, or about 0.5-20 g/head/day.

A dose of choline may be administered to a target animal in an amount effective to increase the amount of nitric oxide produced by arginine in the target animal. The dose of choline may also be administered to a target animal in an amount effective to produce a vasodilatory effect in the target animal. A workable dose of choline may comprise about 0.001-10% the total weight of feed/head/day. The dosage range for choline may be about 0.03-10%, about 0.1-10%, about 0.3-9%, about 0.7-8%, about 1-7%, or about 2-6% the total weight of feed/head/day. The lower end of the dosage range for choline may be about 0.03%, 0.04%, 0.05%, 0.06%, 0.07%, 0.08%, 0.09%, 0.1%, 0.13%, 0.15%, 0.17%, 0.2%, 0.23%, 0.25%, 0.27%, 0.3%, 0.4%, 0.5%, 0.6%, 0.7%, 0.8%, 0.9%, 1%, 2%, 3%, 4%, 5%, 6% or 7% the total weight of feed/head/day. The upper end of the dosage range for choline may be about 10%, 9%, 8%, 7%, 6%, 5%, 4%, or 3% the total weight of feed/head/day. In one example, when the target animal is a chicken, the dose of choline may be administered an amount ranging from about 0.001-30 g/head/day, about 0.1-25 g/head/day, or about 0.5-20 g/head/day.

A dose of one or more ascorbyl compounds may be administered to a target animal in an amount effective to improve stress endurance. Stress endurance may be measured by physiological parameters, for example, creatine kinase (CK), lactate dehydrogenase (LDH), the concentration of corticosterone, the concentration of adreno-cortical hormone, or the heterophil to lymphocyte ratio. A workable dose of the ascorbyl compound may comprise about 0.001-10% the total weight of feed/head/day. The dosage range for the ascorbyl compound may be about 0.015-10%, about 0.04-9%, about 0.1-8%, about 0.5-7%, or about 1-6% the total weight of feed/head/day. The lower end of the dosage range for the ascorbyl compound may be about 0.015%, 0.016%, 0.017%, 0.018%, 0.019%, 0.02%, 0.025%, 0.03%, 0.035%, 0.04%, 0.045%, 0.05%, 0.055%, 0.06%, 0.065%, 0.07%, 0.075%, 0.08%, 0.085%, 0.09%, 0.095%, 0.1%, 0.2%, 0.3%, 0.4%, 0.5%, 0.6%, 0.7%, 0.8%, 0.9%, 1%, 2%, 3%, 4%, 5%, or 6% the total weight of feed/head/day. The upper end of the dosage range for the ascorbyl compound may be about 10%, 9%, 8%, 7%, 6%, 5%, 4%, 3%, or 2% the total weight of feed/head/day. In one example, when the target animal is a chicken, the dose of the ascorbyl compound may be administered in an amount ranging from about 0.001-30 g/head/day, about 0.05-25 g/head/day, or about 0.1-20 g/head/day.

A dose of zinc may be administered to a target animal in an amount effective to improve stress endurance. A workable dose of zinc may comprise about 0.001-10% the total weight of feed/head/day. The dosage range for zinc may be about 0.001-10%, about 0.006-10%, about 0.01-10%, about 0.3-9%, about 0.7-8%, about 1-7%, or about 2-6% the total weight of feed/head/day. The lower end of the dosage range for zinc may be about 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.2%, 1.4%, 1.6%, 1.8%, 2%, 3%, 4%, 5%, or 6% the total weight of feed/head/day. The upper end of the dosage range for choline may be about 10%, 9%, 8%, 7%, 6%, 5%, 4%, 3%, or 2% the total weight of feed/head/day. In one example, when the target animal is a chicken, the dose of zinc may be administered in an amount ranging from about 0.001-30 g/head/day, about 0.05-25 g/head/day, or about 0.1-20 g/head/day.

The doses of arginine, choline, the ascorbyl compound, and zinc may be administered to a chicken in amounts sufficient to improve the feed conversion ratio compared to administering arginine alone, and possibly to reduce Woody Breast syndrome. To determine these sufficent dosages, a study may be conducted on a population of chickens. The study may compare chickens that are given a mixture of one or more of arginine, choline, the ascorbyl compound, and zinc to chickens that are given arginine alone and determine which dosages yield a statistically significant reduction in Woody Breast syndrome or a statistically significant improvement in feed conversion ratio. The study may also compare chickens that are given a mixture of one or more of arginine, choline, the ascorbyl compound, and zinc to chickens that are not given the mixture and determine which dosages yield a statistically significant reduction in Woody Breast syndrome.

The doses of arginine, choline, the ascorbyl compound, and zinc may also be administered to a flock of chickens in amounts sufficient to reduce rates of death on arrival compared to administering arginine alone. To determine the dosages sufficient to reduce the rates of death on arrival, a study may be conducted on a population of chickens. The study may compare chickens that are given a mixture of arginine, choline, the ascorbyl compound, and zinc to chickens that are given arginine alone and determine which dosages yield a statistically significant reduction in death on arrival. The study may also compare chickens that are given a mixture of arginine, choline, the ascorbyl compound, and zinc to chickens that are not given the mixture and determine which dosages yield a statistically significant reduction in rates of death on arrival.

The doses of arginine, choline, the ascorbyl compound, and zinc may be administered to one or more target animals over a period of time. The period of time may be anywhere from about 1 hour to about 100 days, and in some instances about 100, 50, 28, 21, 14, 13, 12, 11, 10, 9, 8, 7, 6, 5, 4, 3, 2, or 1 day(s) or about 22, 20, 18, 14, 12, 11, 10, 9, 8, 7, 6, 5, 4, 3, 2, or 1 hour(s). The period of time may be in the range of about 1 hour to 50 days, about 1 hour to 28 days, about 1 hour to 21 days, about 1 hour to 14 days, about 1 hour to 7 days, or about 2 hours to 7 days. The period of time may be prior to or after feed withdrawal, that is, prior to or after a farmer stops feeding an animal before catching and transporting the animal to be harvested and processed at a producer's facility. The doses may be administered to an animal, for example via a water supply or a supplement, even after feed withdrawal. It is contemplated that the period of time may be the lifetime of the animal (i.e., starting at about age day 1 until the last day of life) or any suitable portion thereof.

It should be understood that the duration of administration may be any suitable amount of time effective to alleviate one or more conditions caused by vasoconstriction or oxidative stress, such as Woody Breast syndrome or death on arrival, or to improve feed conversion ratio. The timing of administration may depend on when the target animal is prone to develop conditions that may be alleviated by increased nitrous oxide production or reduced oxidative stress. The doses of arginine, choline, the ascorbyl compound, and zinc may be administered during the early life of the target animal (e.g., starting at age day 1, 2, 3, 4, 5, 6, 7, etc.) to optimize early nutrition and protect the target animal from environmental stresses throughout the growing period. The doses of arginine, choline, the ascorbyl compound, and zinc may also be administered to a target animal during periods of stress, for example, during or prior to catching and transport of the animal, prior to or after feed withdrawal, or during periods of heat stress.

It is contemplated that the doses of arginine, choline, the ascorbyl compound, and zinc may be administered to a target animal jointly or in one or more separate doses. For example, one or more of the arginine, choline, the ascorbyl compound, and zinc doses may be administered to a target animal via a feed product while others are administered via a water supply.

The doses of arginine, choline, the ascorbyl compound, and zinc may be administered to one or more target animals in the form of an animal feed product. The animal feed product may be an animal feed, feed additive, feed supplement, water supplement, nutrient injection, or other appropriate product. The animal feed product may be administered to the target animal in a variety of forms such as liquid or dry form. It is contemplated that the animal feed product may include arginine, choline, the ascorbyl compound, and zinc or it may include any combination of thereof. For example, the animal feed product may include arginine and choline but not zinc or the ascorbyl compound in amounts sufficient to deliver the aforementioned dosages.

In one embodiment, the doses of arginine, choline, the ascorbyl compound, and zinc are administered to one or more target animals in the form of an animal feed. The animal feed may be a dry animal feed. “Dry” does not connote the complete absence of moisture, and it is understood that the feed may contain some moisture as is naturally present or introduced during conventional shipping, handling, and storage. The animal feed may include arginine in amount ranging from about 0.001-10%, about 0.1-10%, about 0.2-10%, about 2-9%, about 3-8%, or about 4-7% by dry basis weight of the animal feed. The animal feed may include choline in an amount ranging from about 0.001-10%, about 0.03-10%, about 0.1-10%, about 0.3-9%, about 0.5-8%, about 0.7-7%, or about 1-6% by dry basis weight of the animal feed. The animal feed may include one or more ascorbyl compound in an amount ranging from about 0.001-10%, about 0.015-10%, about 0.04-9%, about 0.06-8%, about 0.08-7%, or about 1-6% by dry basis weight of the animal feed. The animal feed may include zinc in an amount ranging from about 0.001-10%, about 0.001-10%, about 0.006-10%, about 0.01-10%, about 0.3%-9%, about 0.5-8%, about 0.7-7%, or about 1-6% by dry basis weight of the animal feed. In the animal feed, the weight ratio of L-arginine to the total of arginine, choline, the ascorbyl compound, and zinc may be in the range of about 0.4:1 to 0.95:1, about 0.5:1 to 0.9:1, or about 0.6:1 to 0.8:1. The weight ratio of choline to the total of arginine, choline, the ascorbyl compound, and zinc in the animal feed product may be in the range of about 0.01:1 to about 0.3:1, about 0.05:1 to 0.2:1, or about 0.07:1 to 0.15:1. The weight ratio of the ascorbyl compound to the total of arginine, choline, the ascorbyl compound, and zinc in the animal feed product may be in the range of about 0.001:1 to 0.03:1, about 0.005:1 to 0.025:1, or about 0.01 to 0.02. The weight ratio of zinc to the total of arginine, choline, the ascorbyl compound, and zinc may be in the range of about 0.01:1 to about 0.3:1, about 0.05:1 to 0.2:1, or about 0.07:1 to 0.15:1.

The animal feed may further include additional materials. For instance, the animal feed may include one or more carriers or anticaking agents, or, more generally, any other suitable nutritive sources, formulation aids, or ingredients.

Suitable carriers include, but are not limited to, inositol, maltodextrin, modified food starch, pectin, and amylopectin. It is also contemplated that the feed product may be water-based, in which case a suitable carrier may be water.

Suitable anticaking agents include silica, silica aerogel, calcium silicate, aluminum calcium silicate, magnesium silicate, sodium aluminosilicate, hydrated sodium calcium aluminosilicate, or tricalcium silicate. One or more anticaking agent may be included in the animal feed in an amount effective to prevent caking or clumping of the animal feed during storage. One or more anticaking agents may also be included the animal feed in an amount ranging from about 0.001-2% by weight of the animal feed.

In another embodiment, the doses of arginine, choline, the ascorbyl compound, and zinc are administered to one or more target animals via a feed supplement that is added to a water supply to be consumed by the target animal(s).

A workable amount of arginine in the feed supplement may be about 1-100% arginine by weight of the feed supplement. The upper end of the range of arginine in the feed supplement may be about 90%, 85%, 80%, 75%, 70%, 65%, 60%, 55%, 50%, 45%, 40%, 35%, 30%, 25%, 20%, 15%, 10%, or 5% by weight; and the lower end of the range of arginine may be about 1%, 5%, 10%, 15%, 20%, 30%, 35%, 40%, 45%, or 50% by weight. The feed supplement may include arginine in amount ranging from about 1-50%, about 10-50%, about 10-45%, about 15-40%, or 20-35% by weight of the feed supplement.

A workable amount of choline in the feed supplement may be about 1-100% choline by weight of the feed supplement. The upper end of the range of choline in the feed supplement may be about 90%, 85%, 80%, 75%, 70%, 65%, 60%, 55%, 50%, 45%, 40%, 35%, 30%, 25%, 20%, 15%, 10%, or 5% by weight; and the lower end of the range of choline may be about 1%, 5%, 10%, 15%, 20%, 30%, 35%, 40%, 45%, or 50% by weight. The feed supplement may include choline in an amount ranging from about 1-50%, about 10-50%, about 10-45%, about 15-40%, about 20-35%, or about 20-30% by weight of the feed supplement.

A workable amount of the ascorbyl compound in the feed supplement may be about 1-100% ascorbyl compound by weight of the feed supplement. The upper end of the range of the ascorbyl compound in the feed supplement may be about 90%, 85%, 80%, 75%, 70%, 65%, 60%, 55%, 50%, 45%, 40%, 35%, 30%, 25%, 20%, 15%, 10%, or 5% by weight; and the lower end of the range of the ascorbyl compound may be about 1%, 5%, 10%, 15%, 20%, 30%, 35%, 40%, 45%, or 50% by weight. The feed supplement may include one or more ascorbyl compounds in an amount ranging from about 1-10%, about 2-8%, about 3-7%, or about 4-6% by weight of the feed supplement.

A workable amount of zinc in the feed supplement may be about 1-100% zinc by weight of the feed supplement. The upper end of the range of zinc in the feed supplement may be about 90%, 85%, 80%, 75%, 70%, 65%, 60%, 55%, 50%, 45%, 40%, 35%, 30%, 25%, 20%, 15%, 10%, or 5% by weight; and the lower end of the range of zinc may be about 1%, 5%, 10%, 15%, 20%, 30%, 35%, 40%, 45%, or 50% by weight. The feed supplement may include zinc in an amount ranging from about 1-15%, about 3-14%, about 4-13%, or about 5-12% by weight of the feed supplement.

The feed supplement may further include one or more carriers, anti-caking agents, or other processing aids in any suitable amount. For example, the feed supplement may include one or more anticaking agents in an amount effective to prevent clumping or caking of the feed supplement or in an amount ranging from about 0.001-2% by weight of the animal feed.

The animal feed products (i.e., animal feeds or feed supplements) prepared in accordance with the present teachings may be administered to one or more target animals in an amount effective to deliver the dosages of arginine, choline, the ascorbyl compound, and zinc described above. It is contemplated that the feed products may be administered to a single animal, but more commonly will be administered to a heard or flock of similar animals. The animal feed products described herein may be prepared and tailored for, and administered to, a variety of animals, including but not limited to, ruminant and monogastric meat producing animals such as beef and dairy cattle, swine, sheep, lambs and goats, farm livestock including equine animals, poultry such as chickens, ducks, turkeys, and aquaculture farmed fish and shrimp for human consumption. In some examples, the feed product may be tailored for broiler chickens or broiler chicken starters.

In one exemplary feeding protocol, the feed supplement described above is added to a water supply to be consumed by one or more target animals.

In the feeding protocol, arginine, choline, the ascorbyl compound, and zinc are be blended in the ratios described above to prepare the feed supplement. The ingredients may be mixed using any using any suitable blending or mixing equipment.

Optionally, the feed supplement may be pre-diluted with water to create a stock solution. Pre-dilution may help to evenly distribute the feed supplement in the water supply. Additionally, pre-dilution may facilitate the addition of the dry feed supplement to distribution piping that is used to administer the water supply to the target animal(s). The feed supplement may be pre-diluted with any suitable quantity of water and may depend on the quantity of feed supplement to be added to the water supply.

The feed supplement is then added to a water supply to be consumed by the target animal(s). The feed supplement may be added to the water supply to achieve a feed supplement concentration ranging from about 0.001-2000 g/gallon, about 1000-2000 g/gallon, about 1500-2000 g/gallon, about 1200-1800 g/gallon, about 1-100 g/gallon, about 1-75 g/gallon, about 10-30 g/gallon, about 5-25 g/gallon, about 10-20 g/gallon, about 1-10 g/gallon, or about 1-5 g/gallon. The upper end of the range of the feed supplement concentration in the water supply may be about 2000, 1800, 1600, 1400, 1200, 1000, 800, 600, 400, 200, 100, 80, 60, 50, 45, 40, 35, 30, 25, 20, 15, 10, or 5 g/gallon. The lower end of the range of the feed supplement concentration in the water supply may be about 1000, 800, 600, 400, 200, 100, 80, 60, 50, 45, 40, 35, 30, 25, 20, 15, 10, 5, 1, 0.5, 0.1, or 0.01 g/gallon.

The water supply, to which the feed supplement has been added, is administered to the group of animals over a period of time, for example hours or days, as described above. It is contemplated that this feeding protocol may help an animal, such as a chicken, endure heat stress and the stress from starving, catching, and transporting. The amount of the water supply administered to the target animal(s) and the concentration of feed supplement in the water supply may be adjusted the deliver the dosages of arginine, choline, the ascorbyl compound, and zinc described above.

The water supply may be administered to one or more target animals in accordance with suitable animal management practices. For example, the daily amount of water administered to the target animal(s) may be increased to accommodate fast-growing animals. Further, the daily amount of water administered to the target animal(s) may be adjusted seasonally, for example, to accommodate increased water intake requirements during hot weather. During periods of hot weather, the water intake requirements for a target animal may double. Thus, a lower concentration of feed supplement in the water supply may be required to deliver the desired dosages of arginine, choline, the ascorbyl compound, and zinc.

It is contemplated that, in this feeding protocol, one or more of arginine, choline, the ascorbyl compound, and zinc may be not be incorporated to the feed supplement and administered via the water supply and, instead, may be administered via another feed product such as a dry feed. That is, one or more of arginine, choline, the ascorbyl compound, and zinc may be removed from the feed supplement and, instead of being administered via the water supply, may be administered via other nutrient sources.

The doses of arginine, choline, the ascorbyl compound, and zinc may also be provided in an animal feeding kit. The animal feeding kit may include one or more doses of arginine, choline, the ascorbyl compound, and zinc and may include doses for a single animal or for a group of similar animals. The animal feeding kit may include doses sufficient for administration according to one or more of the feeding protocols described above. In some cases, the animal feeding kit may include one or more ingredients for a feed supplement to be added to a water supply or a dry feed.

The present disclosure contemplates that administering choline with arginine, whether separately or together, enhances efficacy of arginine with respect to nitric oxide production and, as a response, increases the vasodilatory effect caused by nitric oxide. Further, it is believed that administering one or more antioxidants, such as zinc or the ascorbyl compound, with arginine and choline may have a synergistic effect that both increases nitric oxide production and reduces oxidative stress. Administering this synergistic blend is intended to manage heart disease and oxidative stress in a target animal. Further, with increased vasodilation and reduced oxidative stress, more oxygen or electron donors and free calcium ions may be made available for cellular metabolism which yields more oxygen or electron donors for other reactions, such as protein synthesis.

The following non-limiting examples are provided for illustration.

### EXAMPLE 1

To prepare a boiler starter feed supplement, L-arginine, choline chloride 60%, vitamin-C (i.e., ascorbic acid), and zinc sulfate monohydrate are blended in the amounts detailed in Table 1. The weight percentages in Table 1 are on a dry solids basis for a feed supplement to be added to a water supply.

TABLE 1
Feed Supplement

| Ingredient | Amount (g) | Wt. % |
|---|---|---|
| L-arginine | 1083 | 32.2 |
| Choline Chloride 60% | 1813 | 53.9 |
| Vitamin-C | 162 | 4.8 |
| Zinc Sulfate Monohydrate (ZiSO₄•H₂O) | 305 | 9.1 |
| Total | 3364 | 100 |

Table 2 provides the amounts of choline and zinc in the blend of Table 1.

TABLE 2
Feed Supplement

| Ingredient | Amount (g) | Wt. % |
|---|---|---|
| Choline | 812 | 24.1 |
| Zinc | 108 | 3.2 |

The 3.4 kg of feed supplement is pre-diluted with 1 gallon of water to create a stock solution. This stock solution is added to a water supply for a flock of starter broiler chicken comprising 242 gallons of water (i.e., about 13.9 g feed supplement/gallon water). The water supply is administered to a flock of approximately 1000 mixed-sex birds for year-round production. The feed supplement is fed slowly to the flock via the water supply over a period of 14 days (i.e., from 0-14 days of age) to deliver a dosage of 0.24 g feed supplement/head/day. This feeding protocol delivers dosages of L-arginine, choline chloride, vitamin-C, and zinc sulfate to the flock in the amounts detailed in Table 3. In this feeding protocol, the total daily feed consumption for each bird is about 40 g/head/day. This application converts to a dosage of approximately 0.2% L-arginine, 0.15% choline, 0.03% Vitamin C, and 0.02% zinc based on total weight of feed/head/day.

TABLE 3

| | Dosage |
|---|---|
| Ingredient | (g/head/day) |
| L-arginine | 0.077 |
| Choline Chloride 60% | 0.13 |
| Vitamin-C | 0.012 |
| Zinc Sulfate Monohydrate (ZiSO₄•H₂O) | 0.022 |
| Total | 0.24 |

This feeding protocol delivers dosages of choline and zinc in the amounts detailed in Table 4.

TABLE 4

| | Dosage |
|---|---|
| Ingredient | (g/head/day) |
| Choline | 0.058 |
| Zinc | 0.008 |

### EXAMPLE 2

To prepare a broiler feed supplement, L-arginine, choline chloride 60%, vitamin-C, and zinc sulfate monohydrate are blended in the amounts detailed in Table 5. The weight percentages in Table 5 are on a dry solids basis for a feed supplement to be added to a water supply.

TABLE 5
Feed Supplement

| | Total Amount | |
|---|---|---|
| Ingredient | (kg) | Wt. % |
| L-arginine | 13.2 | 32.2 |
| Choline Chloride 60% | 22.1 | 53.9 |
| Vitamin-C | 2.0 | 4.8 |
| Zinc Sulfate Monohydrate (ZiSO₄•H₂O) | 3.7 | 9.1 |
| Total | 41.0 | 100 |

Table 6 provides the amounts of choline and zinc in the blend of Table 5.

TABLE 6
Feed Supplement

| Ingredient | Amount (kg) | Wt. % |
|---|---|---|
| Choline | 9.9 | 24.1 |
| Zinc | 1.3 | 3.2 |

The 41 kg of feed supplement is pre-diluted with an appropriate amount of water to create a stock solution. This stock solution may be added to a water supply comprising 2579 gallons of water (i.e., about 15.9 g feed supplement/gallon water). Alternatively, the stock solution may be prepared and added to the water supply in several batches over the 50-day period. For example, a first batch of stock solution may include a fifth of feed supplement for addition to a fifth of the water supply during the first 10 days, a second batch may include fifth of the feed supplement for addition to fifth water supply during the second 10 days, and so forth for the remaining days. The water supply is administered to a flock of 1000 mixed-sex broiler for year-round production. The feed supplement is fed slowly to the flock via the water supply over a period of 50 days to deliver a dosage of 0.82 g feed supplement/head/day. This feeding protocol delivers dosages of L-arginine, choline chloride, vitamin-C, and zinc sulfate to the flock in the amounts detailed in Table 7. In this feeding protocol, the total daily feed consumption for each bird is about 130 g/head/day. This application converts to a dosage of approximately 0.2% L-arginine, 0.15% choline, 0.03% vitamin-C, and 0.02% zinc based on total weight of feed/head/day.

TABLE 7

| | Dosage |
|---|---|
| Ingredient | (g/head/day) |
| L-arginine | 0.26 |
| Choline Chloride 60% | 0.44 |
| Vitamin-C | 0.04 |
| Zinc Sulfate Monohydrate (ZiSO₄•H₂O) | 0.074 |
| Total | 0.82 |

This feeding protocol delivers dosages of choline and zinc to the flock in the amounts detailed in Table 8.

TABLE 8

| | Dosage |
|---|---|
| Ingredient | (g/head/day) |
| Choline | 0.198 |
| Zinc | 0.026 |

### EXAMPLE 3

Under heat stress, birds may drink more water than average. The total amount of feed supplement intake will be the same as in Example 2 (see Tables 5 and 6) while the water intake may be doubled. Prepare a broiler feed supplement, L-arginine, choline chloride 60%, vitamin-C, and zinc sulfate monohydrate are blended in the amounts referenced in Table 5. The 41 kg of feed supplement is pre-diluted with an appropriate amount of water to create a stock solution. This stock solution as added to a water supply comprising 5158 gallons of water (i.e., about 7.94 g feed supplement/gallon water). The stock solution may be prepared and added to the water supply in several batches over the 50-day period. For example, a first batch of stock solution may include a fifth of feed supplement for addition to a fifth of the water supply during the first 10 days, a second batch may include fifth of the feed supplement for addition to fifth water supply during the second 10 days, etc. The water supply is administered to a flock of 1000 fast growing birds during hot weather. The feed supplement is fed slowly to the flock via the water supply over a period of 50 days to deliver a dosage of 0.82 g feed supplement/head/day. This feeding protocol delivers dosages of L-arginine, choline chloride, vitamin-C, and zinc sulfate to the flock in the amounts detailed in Table 7 above. This feeding protocol delivers dosages of choline and zinc in the amounts detailed in Table 8 above.

EXAMPLE 4

To a flock of 100 broiler chickens, 659.6 g L-arginine/head, 659.6 g choline/head, 659.6 g vitamin-C/head, and 659.6 g zinc/head are administered over a period of 50 days. The doses are administered according to the feeding schedule in Table 9. The dosages of L-arginine, choline, vitamin-C, and zinc in Table 9 each comprise 10% of the daily feed consumption of each broiler chicken starter.

TABLE 9

| | Daily Dry | L-arginine | Choline | Vitamin-C | Zinc |
|---|---|---|---|---|---|
| | Feed | Dosage | Dosage | Dosage | Dosage |
| Age | Consumption | (g/head/ | (g/head/ | (g/head/ | (g/head/ |
| (Days) | (g/head/day) | day) | day) | day) | day) |
| 1 | 20 | 2 | 2 | 2 | 2 |
| 2 | 20 | 2 | 2 | 2 | 2 |
| 3 | 20 | 2 | 2 | 2 | 2 |
| 4 | 20 | 2 | 2 | 2 | 2 |
| 5 | 20 | 2 | 2 | 2 | 2 |
| 6 | 20 | 2 | 2 | 2 | 2 |
| 7 | 25 | 2.5 | 2.5 | 2.5 | 2.5 |
| 8 | 37 | 3.7 | 3.7 | 3.7 | 3.7 |
| 9 | 43 | 4.3 | 4.3 | 4.3 | 4.3 |
| 10 | 50 | 5 | 5 | 5 | 5 |
| 11 | 57 | 5.7 | 5.7 | 5.7 | 5.7 |
| 12 | 64 | 6.4 | 6.4 | 6.4 | 6.4 |
| 13 | 72 | 7.2 | 7.2 | 7.2 | 7.2 |
| 14 | 74 | 7.4 | 7.4 | 7.4 | 7.4 |
| 15 | 78 | 7.8 | 7.8 | 7.8 | 7.8 |
| 16 | 85 | 8.5 | 8.5 | 8.5 | 8.5 |
| 17 | 91 | 9.1 | 9.1 | 9.1 | 9.1 |
| 18 | 103 | 10.3 | 10.3 | 10.3 | 10.3 |
| 19 | 110 | 11 | 11 | 11 | 11 |
| 20 | 114 | 11.4 | 11.4 | 11.4 | 11.4 |
| 21 | 118 | 11.8 | 11.8 | 11.8 | 11.8 |
| 22 | 123 | 12.3 | 12.3 | 12.3 | 12.3 |
| 23 | 128 | 12.8 | 12.8 | 12.8 | 12.8 |
| 24 | 133 | 13.3 | 13.3 | 13.3 | 13.3 |
| 25 | 137 | 13.7 | 13.7 | 13.7 | 13.7 |
| 26 | 144 | 14.4 | 14.4 | 14.4 | 14.4 |
| 27 | 150 | 15 | 15 | 15 | 15 |
| 28 | 15€ | 15.6 | 15.6 | 15.6 | 15.6 |
| 29 | 160 | 16 | 16 | 16 | 16 |
| 30 | 164 | 16.4 | 16.4 | 16.4 | 16.4 |
| 31 | 167 | 16.7 | 16.7 | 16.7 | 16.7 |
| 32 | 170 | 17 | 17 | 17 | 17 |
| 33 | 174 | 17.4 | 17.4 | 17.4 | 17.4 |
| 34 | 177 | 17.7 | 17.7 | 17.7 | 17.7 |
| 35 | 179 | 17.9 | 17.9 | 17.9 | 17.9 |
| 36 | 182 | 18.2 | 18.2 | 18.2 | 18.2 |
| 37 | 186 | 18.6 | 18.6 | 18.6 | 18.6 |
| 38 | 190 | 19 | 19 | 19 | 19 |
| 39 | 193 | 19.3 | 19.3 | 19.3 | 19.3 |
| 40 | 197 | 19.7 | 19.7 | 19.7 | 19.7 |
| 41 | 203 | 20.3 | 20.3 | 20.3 | 20.3 |
| 42 | 208 | 20.8 | 20.8 | 20.8 | 20.8 |
| 43 | 213 | 21.3 | 21.3 | 21.3 | 21.3 |
| 44 | 218 | 21.8 | 21.8 | 21.8 | 21.8 |
| 45 | 224 | 22.4 | 22.4 | 22.4 | 22.4 |
| 46 | 228 | 22.8 | 22.8 | 22.8 | 22.8 |
| 47 | 231 | 23.1 | 23.1 | 23.1 | 23.1 |
| 48 | 236 | 23.6 | 23.6 | 23.6 | 23.6 |
| 49 | 241 | 24.1 | 24.1 | 24.1 | 24.1 |
| 50 | 243 | 24.3 | 24.3 | 24.3 | 24.3 |
| TOTAL | 6596 | 659.6 | 659.6 | 659.6 | 659.6 |

### EXAMPLE 5

To a flock of 100 broiler chicken starters, 659.6 g L-arginine/head, 659.6 g choline/head, 659.6 g vitamin-C/head, and 659.6 g zinc/head are administered over a period of 50 days. The doses are administered according to the feeding schedule in Table 9. With reference to Table 9, the daily feed consumption includes nutrients consumed from both dry feed and water sources. The doses of zinc detailed in Table 9 are administered to the flock via a dry feed comprising zinc. The doses of L-arginine, choline, and vitamin-C detailed in Table 9 are administered to the flock via a water supply comprising L-arginine, choline, and vitamin-C.

### EXAMPLE 6

To prepare a broiler feed supplement, L-arginine, choline bitartrate, vitamin-C (i.e., ascorbic acid), and zinc sulfate monohydrate are blended in the amounts detailed in Table 10. The weight percentages in Table 10 are on a dry solids basis for a feed supplement to be added to a water supply.

TABLE 10
Feed Supplement

| | Amount | |
|---|---|---|
| Ingredient | (g) | Wt. % |
| L-arginine | 1146 | 26.9 |
| Choline bitartrate | 2865 | 67.2 |
| Vitamin-C | 172 | 4.0 |
| Zinc Sulfate Monohydrate (ZiSO₄•H₂O) | 81 | 1.9 |
| Total | 4264 | 100 |

Table 11 provides the amounts of choline and zinc in the blend of Table 10.

TABLE 11
Feed Supplement

| Ingredient | Amount (g) | Wt. % |
|---|---|---|
| Choline | 1146 | 26.9 |
| Zinc | 29 | 0.7 |

The 4.3 kg of feed supplement is pre-diluted with 1 gallon of water to create a stock solution. This stock solution is added to a water supply for a flock of starter broiler chicken comprising 256 gallons of water (i.e., about 16.7 g feed supplement/gallon water). The water supply is administered to a flock of approximately 1057 mixed-sex birds for year-round production. The feed supplement is fed slowly to the flock via the water supply over a period of 14 days (i.e., from 0-14 days of age) to deliver a dosage of 0.29 g feed supplement/head/day. Again, in alternative embodiments, the stock may be prepared incrementally. In either case, this feeding protocol delivers dosages of L-arginine, choline chloride, vitamin-C, and zinc sulfate to the flock in the amounts detailed in Table 12. In this feeding protocol, the total daily feed consumption for each bird is about 40 g/head/day. This application converts to a dosage of approximately 0.2% L-arginine, 0.2% choline, 0.03% vitamin-C, and 0.005% zinc based on total weight of feed/head/day.

TABLE 12

| | Dosage |
|---|---|
| Ingredient | (g/head/day) |
| L-arginine | 0.077 |
| Choline bitartrate | 0.194 |
| Vitamin-C | 0.012 |
| Zinc Sulfate Monohydrate (ZiSO₄•H₂O) | 0.005 |
| Total | 0.29 |

This feeding protocol delivers dosages of choline and zinc in the amounts detailed in Table 13.

TABLE 13

| | Dosage |
|---|---|
| Ingredient | (g/head/day) |
| Choline | 0.077 |
| Zinc | 0.002 |

### EXAMPLE 7

Additional testing was performed to analyze how different diets affect the feeding, growth, and overall condition of birds. In this example, Aviagen YP X Ross 708 all male birds were analyzed. The study was conducted following stocking density requirements using projected body weights of male Ross 708 broilers as found in Ross Broiler: Nutrition Specifications, 2019.

The birds were analyzed at various periods of growth. The time periods were Starter, Grower, Finisher 1, and Finisher 2. The Starter period was from day 0 to day 14, the Grower period was from day 14 to day 28, the Finisher 1 period was from day 28 to day 42, and the Finisher 2 period was from day 42 to day 49.

Diet 1 was a control prepared according to Ross Broiler: Nutrition Specifications, 2019, for the various growing periods. Birds were fed according to Ross Nutrition Specifications for 3.10-3.50 kg live weight on page 7, Table 4. Diet 2 included the control feed for each period and also added 0.2022% arginine+0.0301% Vitamin C+0.1737% choline bitartate to the dry feed. Feed and water was provided ad libitum from hanging feeders and nipple waterlines.

Upon placement/day of hatch, chicks were fed starter feed for two weeks (d0-14), grower feed for two weeks (d14-28), finisher 1 feed for two weeks (d28-42), and finisher 2 feed for the last week (d42-49). All birds and feed were weighed at placement by pen and at each diet change for performance evaluation. Table 14 below provides feed intake, body weight and feed conversion ratio (FCR) information during the growth periods.

TABLE 14
Performance Outcome

| | Diet 1 | Diet 2 |
|---|---|---|
| Feed intake, kg | | |
| Starter | 0.5197 | 0.5090 |
| Grower | 1.3429 | 1.335 |
| Finisher 1 | 2.0534 | 2.0063 |
| Finisher 2 | 1.1926 | 1.1805 |
| Body weight gain, kg | | |
| Starter | 0.363 | 0.3667 |
| Grower | 0.9045 | 0.9004 |
| Finisher 1 | 1.1746 | 1.1818 |
| Finisher 2 | 0.5607 | 0.586 |
| Body weight, kg | | |
| d14 | 0.4066 | 0.4109 |
| d28 | 1.3104 | 1.3128 |
| d42 | 2.4712 | 2.5048 |
| d49 | 2.9992 | 3.0732 |
| FCR | | |
| Starter | 1.4331 | 1.3895 |
| Grower | 1.4854 | 1.4828 |
| Finisher 1 | 1.7515 | 1.6986 |
| Finisher 2 | 2.2987 | 2.0451 |

Based on a statistical analysis of the data obtained, body weight gain was not affected by the diet in a statistically significant way. However, the feed conversion ratio (FCR) did improve between the two diets. More specifically, Diet 2 resulted in an improved (lower) FCR value than the control in Diet 1 across all growing periods, with a 95% statistical confidence. The improvement in FCR was made relative to the control diet according to the Ross 2019 feeding specifications identified above.

Woody breast characteristics were also analyzed for the diets over the various periods. Breast palpation scores on a 0-3 tactile scale were recorded for a subset of birds (3/pen) at d28, d35, d42, and d49. Visual and tactile woody breast scoring on both breast fillets as well as weight of dissected fillets were performed on a subset of the harvested birds each on d42 and d49. The results are presented below in Table 15.

TABLE 15

| Woody Breast Score: | | |
|---|---|---|
| % Distribution by Diet | Diet 1 | Diet 2 |
| Live bird palpation | | |
| (Same birds weekly over time) | | |
| d28 | | |
| Score 0: Normal | 73.91 | 70.83 |
| Score 0.5: Normal-Moderate | 23.91 | 25 |
| Score 1: Moderate | 2.17 | 4.17 |
| d35 | | |
| Score 0: Normal | 51.16 | 48.94 |
| Score 0.5: Normal-Moderate | 0 | 6.38 |
| Score 1: Moderate | 48.84 | 44.68 |
| d42 | | |
| Score 0: Normal | 53.66 | 43.48 |
| Score 0.5: Normal-Moderate | 2.44 | 2.17 |
| Score 1: Moderate | 43.9 | 54.35 |
| d49 | | |
| Score 0: Normal | 7.69 | 23.33 |
| Score 1: Moderate | 65.38 | 53.33 |
| Score 2: Severe | 26.92 | 23.33 |
| Breast fillet palpation | | |
| (Selection from birds as above, but post-mortem) | | |
| d42 | | |
| Score 0: Normal | 31.25 | 43.75 |
| Score 0.5: Normal-Moderate | 0 | 0 |
| Score 1: Moderate | 68.75 | 56.25 |
| d49 | | |
| Score 0: Normal | 40 | 37.5 |
| Score 1: Moderate | 26.67 | 12.5 |
| Score 2: Severe | 33.33 | 50 |

As found in Table 15 above the birds fed Diet 2 had an improved Normal result at day 42 for breast fillet palpation. In some forms, performance at day 42 may be significant as some consumers prefer slightly smaller breast fillets that are provided at day 42.

Further, it was found that Diet 2 did not appear to adversely affect other properties such as the breast fillet weight, the compressive force and density of the breast fillet, as well as the water holding qualities of the breast meat. Statistical analysis did not find a significant correlation between diet and these properties.

It should be appreciated that the above example and results may be suitable and exemplary for all Ross specifications for various weights, such as found in the above-noted publication.

All methods described herein can be performed in any suitable order unless otherwise indicated herein or otherwise clearly contradicted by context. The use of any and all examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

1. A method of feeding a target animal, comprising administering to the target animal over a period of time:
a dose of L-arginine ranging from about 0.2% to about 10% total weight of feed/head/day;
a dose of choline ranging from about 0.03% to about 10% total weight of feed/head/day;
a dose of an ascorbyl compound ranging from about 0.015% to about 10% total weight of feed/head/day; and
a dose of zinc ranging from about 0.001% to about 10% total weight of feed/head/day.

2. The method of claim 1, wherein the dose of choline ranges from about 0.1% to about 10% total weight of feed/head/day.

3. The method of claim 1, wherein the dose of zinc ranges from about 0.01% to about 10% total weight of feed/head/day.

4. The method of claim 1, wherein the target animal is a broiler chicken.

5. The method of claim 1, wherein the period of time is between about 1 day to about 21 days.

6. The method of claim 1, wherein the period of time is between about 1 day to about 42 days.

7. The method of claim 1, further comprising the step of discontinuing feeding the target animal about 2 to about 24 hours prior to transport.

8. The method of claim 1, wherein the dose of arginine, the dose of choline, the dose of ascorbyl compound, and the dose of zinc are administered to the target animal for about 2 hours to about 7 days prior to catching or transporting the target animal to be harvested and processed.

9. The method of claim 1, wherein the dose of choline is provided by one or more of choline bitartrate, choline L-bitartrate, choline chloride, ferric choline citrate, ferric choline citrate complex, choline pantothenate, and choline xanthate.

10. The method of claim 1, wherein the dose of choline is provided by choline chloride or choline L-bitartrate.

11. The method of claim 1, wherein the ascorbyl compound is one or more of ascorbic acid, ascorbyl palmitate, sodium ascorbate, calcium ascorbate, potassium sorbate, L-ascorbyl-2-polyphosphate, and L-ascorbyl-2-sulfate.

12. (canceled)

13. The method of claim 1, wherein the dose of zinc is provided by one or more of zinc acetate, zinc carbonate, zinc chloride, zinc chloride diamine complex, zinc gluconate, zinc hydroxychloride, zinc oxide, zinc picolinate, zinc propionate, zinc stearate, zinc methionine, and zinc sulfate.

14. The method of claim 1, wherein the dose of zinc is provided by zinc sulfate monohydrate.

15. A method of feeding a chicken comprising administering L-arginine, choline, an ascorbyl compound, and zinc in amounts sufficient to improve the feed conversion ratio.

16. The method of claim 15, wherein the choline is provided by choline chloride or choline bitartrate, the ascorbyl compound is ascorbic acid, and the zinc is provided by zinc sulfate monohydrate.

17. The method of claim 15, wherein the L-arginine, choline, ascorbyl compound, and zinc are administered to the chicken from age day 1 to age day 21.

18. A method of feeding a group of animals, comprising:
adding a feed supplement to a water supply in an amount ranging from about 0.001 g to about 2000 g of feed supplement per gallon of water, the feed supplement comprising:
about 10 wt. % to about 50 wt. % L-arginine,
about 10 wt. % to about 50 wt. % choline,
about 1 wt. % to about 10 wt. % an ascorbyl compound, and
about 1 wt. % to about 15 wt. % zinc; and
administering the water supply to the group of animals over a period of time.

19. The method of claim 18, wherein the period of time is about 1 day to about 21 days.

20. The method of claim 18, wherein the period of time is between about 1 day to about 42 days.

21. The method of claim 18, wherein the period of time is about 2 hours to about 7 days.

22. The method of claim 18, wherein the animal feed supplement further comprises an anti-caking agent in an amount ranging from about 0.001 wt. % to about 2 wt. %.

23. (canceled)

24. An animal feed product comprising:
about 0.001 to about 10 wt. % L-arginine;
about 0.001 to about 10 wt. % choline;
about 0.001 to about 10 wt. % an ascorbyl compound; and
about 0.001 to about 10 wt. % zinc;
wherein the weight ratio of L-arginine to the total of L-arginine, choline, the ascorbyl compound, and zinc is in the range of about 0.5:1 to about 0.9:1,
wherein the weight ratio of choline to the total of L-arginine, choline, the ascorbyl compound, and zinc is in the range of about 0.05:1 to about 0.2:1,
wherein the weight ratio of the ascorbyl compound to the total of L-arginine, choline, the ascorbyl compound, and zinc is in the range of about 0.005:1 to about 0.025:1, and
wherein the weight ratio of zinc to the total of L-arginine, choline, the ascorbyl compound, and zinc is in the range of about 0.05:1 to about 0.2:1.

25. The animal feed product of claim 24, wherein the choline is provided by one or more of choline bitartrate, choline L-bitartrate, choline chloride, ferric choline citrate, ferric choline citrate complex, choline pantothenate, and choline xanthate.

26. The animal feed product of claim 24, wherein the vitamin-C comprises one or more of ascorbic acid, ascorbyl palmitate, sodium ascorbate, calcium ascorbate, potassium sorbate, L-ascorbyl-2-polyphosphate, or L-ascorbyl-2-sulfate.

27. The animal feed product of claim 24, wherein the zinc is provided by one or more of zinc acetate, zinc carbonate, zinc chloride, zinc chloride diamine complex, zinc gluconate, zinc hydroxychloride, zinc oxide, zinc picolinate, zinc propionate, zinc stearate, zinc methionine, and zinc sulfate.

28-33. (canceled)

34. A method of feeding a target animal, comprising administering to the target animal over a period of time:
a dose of L-arginine ranging from about 0.1% to about 10% total weight of feed/head/day;
a dose of choline ranging from about 0.1% to about 10% total weight of feed/head/day;
a dose of an ascorbyl compound ranging from about 0.015% to about 10% total weight of feed/head/day; and
a dose of zinc ranging from about 0.001% to about 10% total weight of feed/head/day.

35. The method of claim 34, wherein the dose of L-arginine ranges from about 0.2% to about 10% total weight of feed/head/day.

36. The method of claim 34, wherein the dose of zinc ranges from about 0.01% to about 10% total weight of feed/head/day.

37-39. (canceled)
